(19) United States
(12) Patent Application Publication
(10) Pub. No.: US 2017/0154266 A1
(43) Pub. Date: Jun. 1, 2017

(54) INTELLIGENT BROWSER ELEMENT CLASSIFICATION IN WEB BROWSERS WHERE MULTIPLE BROWSER ELEMENTS ARE OPEN

(71) Applicant: International Business Machines Corporation, Armonk, NY (US)

(72) Inventors: Eric D. Schultz, Durham, NC (US); Belinda M. Vennam, Durham, NC (US); Ramratan Vennam, Colfax, NC (US); Sai Vennam, Durham, NC (US)

(21) Appl. No.: 14/953,805

(22) Filed: Nov. 30, 2015

(51) Int. Cl. G06N 5/02; G06F 17/27; G06F 17/22

(52) U.S. Cl. CPC G06N 5/022; G06F 17/2247; G06F 17/27

(57) ABSTRACT

A computer program product for intelligent browser element classification in web browsers where multiple browser elements are open is provided. The computer program product includes a computer readable storage medium having program instructions embodied therewith. The program instructions are readable and executable by a processing circuit to cause the processing circuit to identify a set of similar browser elements from among the multiple browser elements from an analysis of the multiple browser elements, analyze each of the browser elements within the set to determine which are normal and which are anomalous and take an action to differentiate the browser elements determined to be anomalous from the browser elements determined to be normal.

### BACKGROUND

The present invention relates to intelligent browser element classification and, more specifically, to intelligent browser element classification in web browsers where multiple browser elements are open.

A software developer often works on several projects at once and, as he commits changes, he may run builds for each project. Such builds could be system verification test (SVT) builds, function verification test (FVT) builds, unit tests and/or other types of builds. Before long it would not be unexpected for the software developer to have ten or more browser elements open from a same Jenkins server. Moreover, in addition to these ten browser elements, he may also have rational team concert (RTC) work items open, source control server items open and personal networking and social media sites open.

In an exemplary case, the software developer may have ten Jenkins server build browser elements open, five RTC work item browser elements open and three GitHub repository browser elements open for a total of eighteen browser elements open. Many, if not all of the pages associated with the eighteen browser elements, may have asynchronous JavaScript and XML (AJAX) style content updating where the corresponding browser element can be left open until a later status check. In such a case, for ten Jenkins server build browser elements, it may be helpful for the software developer to periodically check each one to determine if his builds are succeeding or failing but, since all of the eighteen browser elements generally look alike and may be shortened due to a lack of space, the software developer may have to manually click through each browser element to find the one he is looking for (e.g., a failed Jenkins server build browser element amongst the other ten).

In conventional browsers, there is no easy way for the software developer in the example given above to find a conclusive event that happened in any one of his eighteen open browser elements. Thus, if one of his builds fails, he has no efficient way to find it and address the failure besides manually clicking through the entire lot.

### SUMMARY

According to an embodiment of the present invention, a computer program product for intelligent browser element classification in web browsers where multiple browser elements are open is provided. The computer program product includes a computer readable storage medium having program instructions embodied therewith. The program instructions are readable and executable by a processing circuit to cause the processing circuit to identify a set of similar browser elements from among the multiple browser elements from an analysis of the multiple browser elements, analyze each of the browser elements within the set to determine which are normal and which are anomalous and take an action to differentiate the browser elements determined to be anomalous from the browser elements determined to be normal.

According to another embodiment of the present invention, a computing system for intelligent browser element classification in web browsers where multiple browser elements are open is provided. The computing system includes a computer readable storage medium having instructions stored thereon that are executable by a processing circuit to cause the processing circuit to identify a set of similar browser elements from among the multiple browser elements from an analysis of the multiple browser elements, analyze each of the browser elements within the set to determine which are normal and which are anomalous and take an action to differentiate the browser elements determined to be anomalous from the browser elements determined to be normal.

According to yet another embodiment of the present invention, a computer-implemented method for intelligent browser element classification in web browsers where multiple browser elements are open is provided. The computer-implemented method includes identifying a set of similar browser elements from among the multiple browser elements from an analysis of the multiple browser elements, analyzing each of the browser elements within the set to determine which are normal and which are anomalous and taking an action to differentiate the browser elements determined to be anomalous from the browser elements determined to be normal.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a schematic illustration of a computing system in accordance with embodiments;

FIG. 2 is a schematic diagram of a composition of a first computing device of the computing system of FIG. 1;

FIG. 3 is a screenshot of a web browser with multiple browser elements open in accordance with embodiments;

FIG. 4 is a schematic illustration of a computer program product for intelligent browser element classification in web browsers where multiple browser elements are open;

FIG. 5 is a graphical depiction of a deployment of the computer program product of FIG. 4 in accordance with embodiments;

FIG. 6 is a graphical depiction of a deployment of the computer program product of FIG. 4 in accordance with alternative embodiments;

FIG. 7 is a flow diagram illustrating a deployment process of the computer program product of FIGS. 4-6; and

FIG. 8 is a flow diagram illustrating a computer-implemented method for intelligent browser element classification in web browsers where multiple browser elements are open.

### DETAILED DESCRIPTION

As will be described below, a set of browser elements are identified from a larger set based on a document object model (DOM) tree comparison or another similar type of comparison algorithm. Once that set of browser elements is created, further analysis on browser element content, incoming traffic or AJAX updates is conducted to determine whether any of the browser elements within the set are anomalous. If there are, those anomalous browser elements are highlighted or otherwise distinguished from the normal browser elements within the set.

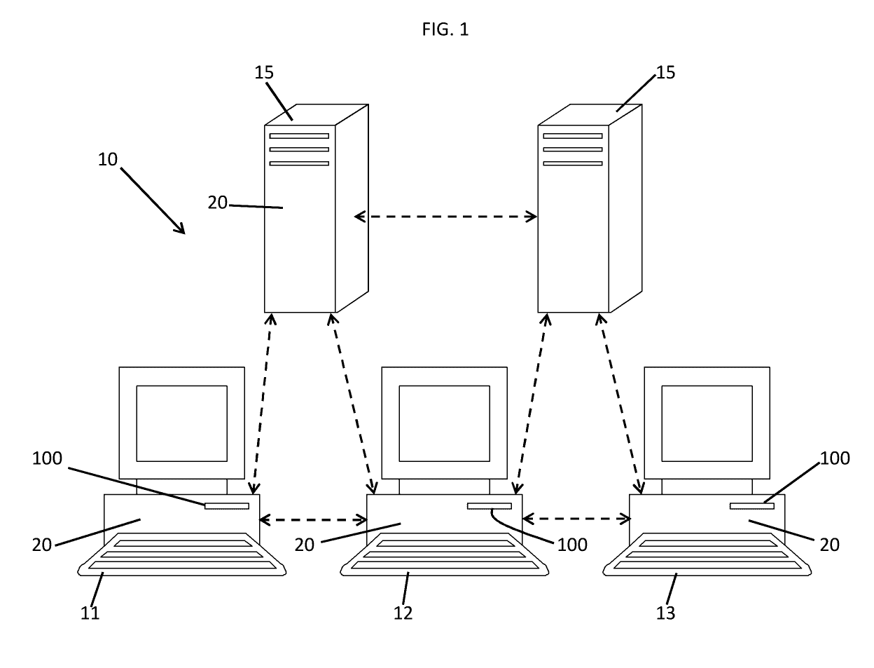

With reference to FIG. 1, a computing system 10 is provided and may be configured for example as an enterprise computing system or as a personal computing system. In either case, the first computing system 10 includes first, second and third computing devices 11, 12 and 13 and servers 15 which are configured to be networked together for communication purposes. Each of the first, second and third computing devices 11, 12 and 13 and the servers 15 may include among other features a processing circuit 20, a display, user input devices and a networking unit as well as a computer program product 100 for intelligent browser element classification in web browsers where multiple browser elements are open.

As used herein, the term browser element may refer to any one of one or more tabs of a browser application that has one or more windows open. Alternatively, the term may refer to any one or more of multiple open windows of a browser application. Thus, in a case where a single window of a browser application is open on a client computer with multiple tabs being activated, each tab is a browser element. Meanwhile, in that same case, if multiple windows are open on the client computer and each window has multiple tabs being activated, each of the tabs from both open windows is a browser element. Conversely, in a case where multiple windows with only one tab of a browser application are open on the client computer, each individual window is a browser element. In yet another case, multiple windows of a browser application may be open with one window having only one tab activated and another window having multiple tabs activated, the window with one tab activated may be a browser element while each individual tab in the other window is a browser element.

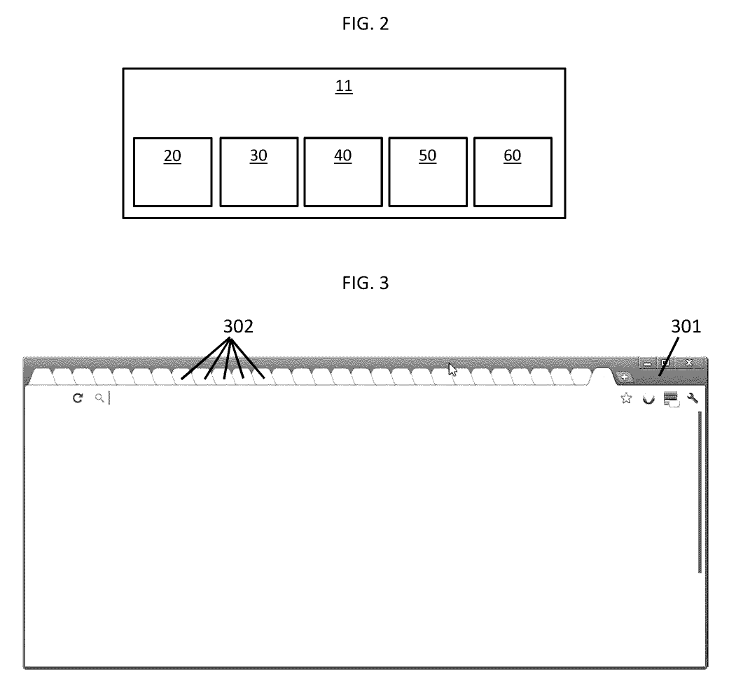

With reference to FIG. 2, a composition of any one of the first, second or third computing devices 11, 12 and 13 or any of one of the servers 15 is illustrated. For the purposes of clarity and brevity, the composition illustrated and described herein will be that of the first computing device 11 although it is to be understood that any of the first, second or third computing devices 11, 12 and 13 or the servers 15 could have been chosen for discussion.

As shown in FIG. 2, the first computing device 11 includes the processing circuit 20, a memory unit 30, a display unit 40, user interface devices 50 and a networking unit 60. The processing circuit 20 may be provided as a micro-processor, a central processing unit (CPU) or any other suitable processing device. The memory unit 30 may be provided as random access memory (RAM), read only memory (ROM) or any other suitable type of storage. The display unit 40 may be provided as a monitor and is configured to display data and information as well as a graphical user interface to an administrator or user of the first computing device 11. The user interface devices 50 may be provided as a mouse and a keyboard combination and are configured to allow the administrator or user to input commands to the processing circuit 20. The networking unit 60 may be provided as an Ethernet or other suitable networking device by which the first, second and third computing devices 11, 12 and 13 and servers 15 are communicative with each other and with external networks, such as a local area network (LAN), a wide area network (WAN) and the Internet.

Where the user of the first computing device 11 is a software developer, the user may use the first computing device 11 to work on several projects at once. In accordance with embodiments and, with reference to FIG. 3, a large number of these projects may involve the use of a single web browser 301 with multiple browser elements 302 open at once. The single web browser 301 and the open browser elements 302 are displayed on the display unit 40 (see FIGS. 1 and 2) in accordance with commands input by the user via the user interface devices 50 (see FIGS. 1 and 2).

As the user commits changes to one or more of his several projects, he may run builds for each of his projects where such builds could be system verification test (SVT) builds, function verification test (FVT) builds, unit tests and/or other types of builds. Eventually, the user may have several browser elements 302 open and, in an exemplary case, may have Jenkins server build browser elements along with rational team concert (RTC) work item browser elements and GitHub repository browser elements open. For this exemplary case, many, if not all of the pages associated with the open browser elements 302, may have asynchronous JavaScript and XML (AJAX) style content updating capability where the corresponding browser element 302 can be left open until a later status check is undertaken by the user. In such a case, for the Jenkins server build browser elements, it may be helpful for the user to periodically check each one to determine if his builds are succeeding or failing.

While conventional browsers do not provide for an easy way for the user in the example given above to find a conclusive event that happened in any one of his open browser elements 302, the computer program product 100 provides for the creation of a set of the browser elements 302 that are identified from all of the browser elements based on, for example, a DOM tree comparison, further analysis on browser element content for those browser elements 302 in the set to determine whether any of the browser elements 302 within the set are anomalous and the taking of an action to differentiate the browser elements 302 determined to be anomalous from the browser elements 302 determined to be normal.

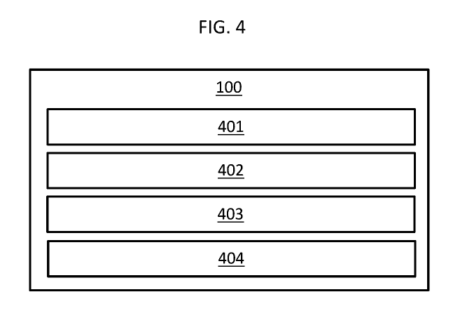

With reference to FIG. 4, the computer program product 100 for intelligent browser element classification in web browsers where multiple browser elements are open includes a computer readable storage medium 1001 and may be installed in the memory unit 30 of the first computing device 11 as firmware or as lower level executable program instructions. As shown in FIG. 4, the computer program product 100 for intelligent browser element classification in web browsers where multiple browser elements are open has first-fourth sequences of program instructions 401-404 embodied therewith. The first-third sequences of program instructions 401-403 are readable and executable by the processing circuit 20 to respectively cause the processing circuit 20 to identify a set of similar browser elements 302 from among the multiple browser elements 302 from an analysis (e.g., a DOM tree content analysis) of the multiple browser elements 302, to analyze each of the browser elements 302 within the set to determine which are normal and which are anomalous and to take an action to differentiate the browser elements 302 determined to be anomalous from the browser elements 302 determined to be normal. The fourth sequence of program instructions 404 is optionally executable and causes the processing circuit 20 to shorten the appearance of each of the browser elements 302 within the corresponding browser (see browser 301 in FIG. 3).

In accordance with embodiments, the multiple browser elements 302 may include the Jenkins server build browser elements, the RTC work item browser elements and the GitHub repository browser elements of FIG. 3. In these or any other similar cases, an identification of the set of similar browser elements 302 may include a DOM tree crawl for specific web pages, similar web page URLs, similar headers and similar page structures. That is, the Jenkins server build browser elements may be identified as the set. Then, the analysis of each of the Jenkins server build browser elements within the set may include one or more of content, network traffic and AJAX update analyses. In accordance with further embodiments, the taking of the action may include a highlighting or another similar graphical modification of the Jenkins server build browser elements that are determined to be anomalous.

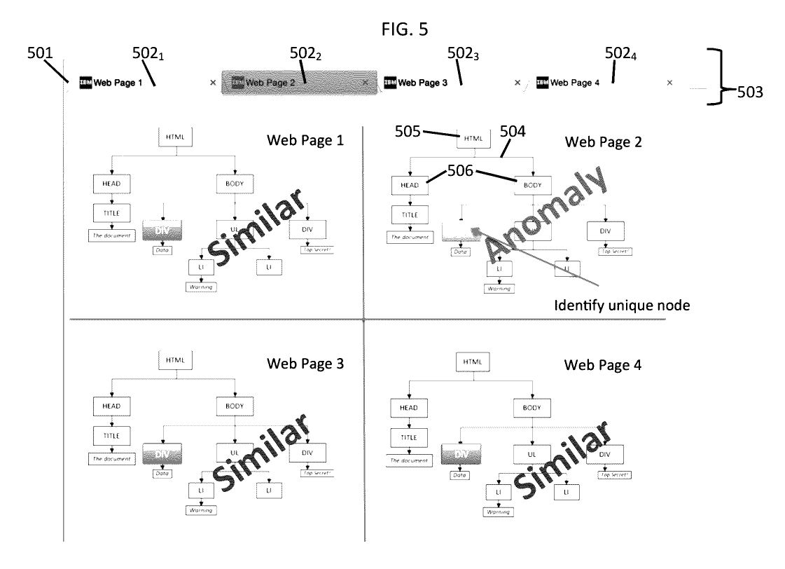

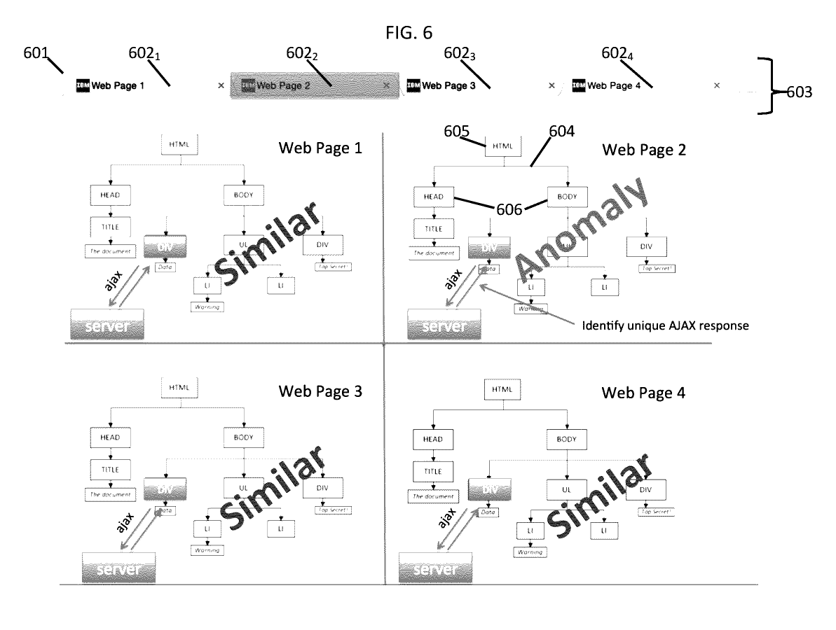

With reference to FIGS. 5 and 6, a graphical depiction of a functional deployment of the computer program product 100 described above is provided and will be described in detail below.

As shown in FIG. 5, a web browser program 501 is being run on the display unit 30 of the first computing device 11 and has four browser elements 502₁, 502₂, 502₃ and 502₄ opened to similar IBM affiliated web pages. During the concurrent execution of the computer program product 100, the processing circuit 20 performs the DOM tree content analysis of the four browser elements 502₁, 502₂, 502₃ and 502₄ and thus determines that they are all affiliated with IBM and thus part of a set of similar browser elements 503 (here, it is to be understood that additional browser elements may be opened that are not affiliated with IBM or otherwise similar to the four illustrated browser elements but are not shown in FIG. 5 for purposes of clarity).

In accordance with embodiments, even if the four browser elements 502₁, 50²₂, 502₃ and 502₄ were not all affiliated with IBM, the DOM tree content analysis would reveal that the content of the web pages associated with each one has a substantially similar tree structure 504, a same HTML top node 505, same HTML sub-nodes 506, etc., and that the similarities would be sufficient to identify the four browser elements 502₁, 502₂, 502₃ and 502₄ as being in the set of similar browser elements 503.

With the continuing execution of the computer program product 100, the processing circuit 20 analyzes each of the four browser elements 502₁, 502₂, 502₃ and 502₄ within the set of similar browser elements 503 to determine which are normal and which are anomalous. Here, the processing circuit 20 will analyze the content or the source code of web pages 1-4, which are respectively associated with each of the four browser elements 502₁, 502₂, 502₃ and 502₄, and will thus determine that web page 2 has a unique sub-node as compared to the others. This determination will allow the processing circuit 20 to determine that the corresponding browser element 502₂ is anomalous and that the other browser elements 502₁, 502₃ and 502₄ are normal. With such determination completed, the processing circuit 20 will continue to execute the computer program product whereby the processing circuit 20 will highlight the anomalous browser element 502₂ and leave the other browser elements 502₁, 502₃ and 502₄ un-highlighted to thereby differentiate the anomalous browser element 502₂.

As shown in FIG. 6, a web browser program 601 is being run on the display unit 30 of the first computing device 11 and has four browser elements 602₁, 602₂, 602₃ and 602₄ opened to similar IBM affiliated web pages. During the concurrent execution of the computer program product 100, the processing circuit 20 performs the DOM tree content analysis of the four browser elements 602₁, 602₂, 602₃ and 602₄ and thus determines that they are all affiliated with IBM and thus part of a set of similar browser elements 603 (here, it is to be understood once again that additional browser elements may be opened that are not affiliated with IBM or otherwise similar to the four illustrated browser elements but are not shown in FIG. 6 for purposes of clarity).

In accordance with embodiments, even if the four browser elements 602₁, 60²₂, 602₃ and 602₄ were not all affiliated with IBM, the DOM tree content analysis would reveal that the content of the web pages associated with each one has a substantially similar tree structure 604, a same HTML top node 605, same HTML sub-nodes 606, etc., and that the similarities would be sufficient to identify the four browser elements 602₁, 602₂, 602₃ and 602₄ as being in the set of similar browser elements 603.

With the continuing execution of the computer program product 100, the processing circuit 20 analyzes each of the four browser elements 602₁, 602₂, 602₃ and 602₄ within the set of similar browser elements 603 to determine which are normal and which are anomalous. Here, the processing circuit 20 will analyze incoming network traffic or AJAX updates of web pages 1-4 (which may be undertaken locally or remotely), which are again respectively associated with each of the four browser elements 602₁, 602₂, 602₃ and 602₄, and will thus determine that web page 2 has a unique AJAX response as compared to the others. This determination will allow the processing circuit 20 to determine that the corresponding browser element 602₂ is anomalous and that the other browser elements 602₁, 602₃ and 602₄ are normal. With such determination completed, the processing circuit 20 will continue to execute the computer program product whereby the processing circuit 20 will highlight the anomalous browser element 602₂ and leave the other browser elements 602₁, 602₃ and 602₄ un-highlighted to thereby differentiate the anomalous browser element 602₂.

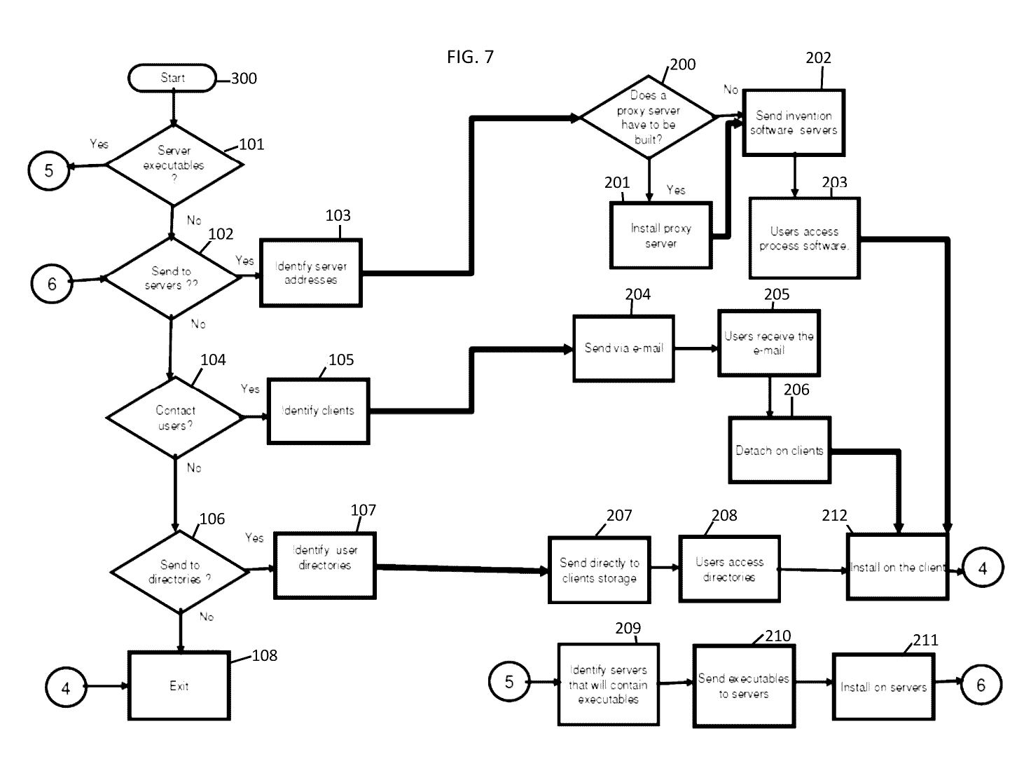

In accordance with embodiments and, with reference to FIG. 7, a deployment process of the computer program product 100 described above is provided. The process begins at block 300 and at block 101 with a determination of whether the first-fourth sequences of program instructions 401-404 will reside on server 15 when executed. If so, then the server 15 is identified at block 209. The first-fourth sequences of program instructions 401-404 are then transferred directly to the server 15 storage via FTP or some other protocol or by copying though the use of a shared file system at block 210 such that the first-fourth sequences of program instructions 401-404 are installed on the servers at block 211.

Next, a determination is made on whether the first-fourth sequences of program instructions 401-404 are to be deployed by having users access to the first-fourth sequences of program instructions 401-404 on server 15 at block 102. If so, the server 15 addresses that will store the first-fourth sequences of program instructions 401-404 are identified at block 103 and a determination is made if a proxy server is to be built at block 200 for storage. A proxy server is a server that sits between a client application, such as a Web browser, of first computing device 11 and server 15 and operates by intercepting all requests to the server 15 to see if it can fulfill the requests itself. If not, the proxy server forwards the request to server 15. The two primary benefits of a proxy server are to improve performance and to filter requests.

If a proxy server is required, then the proxy server is installed at block 201 and the first-fourth sequences of program instructions 401-404 are sent via a protocol, such as FTP, or by being copied directly from the source files to the server 15 files via file sharing at block 202. Another embodiment involves sending a transaction to the (one or more) server 15 that contained the process software, and have the server 15 process the transaction and then receive and copy the process software to the server 15 file system. Once the process software is stored, the users may then access the first-fourth sequences of program instructions 401-404 and copy to the same to their respective client computer file systems at block 203. Alternatively, the server 15 may automatically copy the first-fourth sequences of program instructions 401-404 to each client and then run an installation program for the first-fourth sequences of program instructions 401-404 on each client computer whereby the user executes the program that installs the first-fourth sequences of program instructions 401-404 on his client computer at block 212 and then exits the process at block 108.

At block 104, a determination is made as to whether the first-fourth sequences of program instructions 401-404 are to be deployed by being sent to users via e-mail. If a result of the determination is affirmative, the set of users are identified together with the addresses of the user client computers at block 105 and the first-fourth sequences of program instructions 401-404 are sent via e-mail to each of the users' client computers. The users then receive the e-mail at block 205 and detach the first-fourth sequences of program instructions 401-404 from the e-mail to a directory on their client computers at block 206. The user executes the program that installs the first-fourth sequences of program instructions 401-404 on his client computer at block 212 and then exits the process at block 108.

Lastly, a determination is made on whether the first-eleventh program instructions 501-511 will be sent directly to user directories on their client computers at block 106. If so, the user directories are identified at block 107 and the process software is transferred directly to the user's client computer directories at block 207. This can be done in several ways such as, but not limited to, sharing the file system directories and then copying from the sender's file system to the recipient user's file system or, alternatively, using a transfer protocol such as File Transfer Protocol (FTP). The users access the directories on their client file systems in preparation for installing the first-fourth sequences of program instructions 401-404 at block 208, execute the program that installs the first-fourth sequences of program instructions 401-404 at block 212 and then exit the process at block 108.

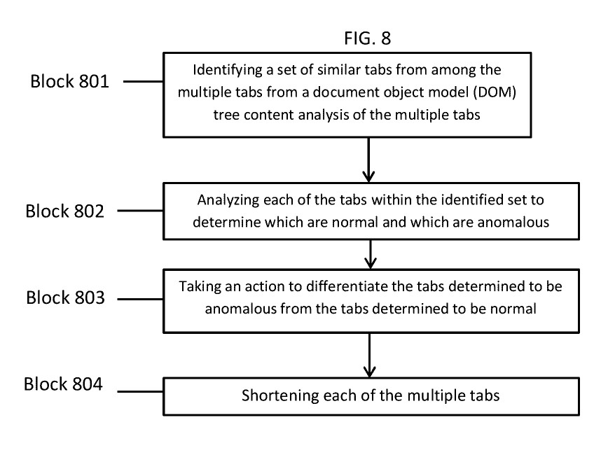

With reference to FIG. 8, a computer-implemented method for intelligent browser element classification in web browsers where multiple browser elements are open is provided. The computer-implemented method includes identifying a set of similar browser elements from among the multiple browser elements from an analysis (e.g., a document object model (DOM) tree content analysis) of the multiple browser elements at block 801, analyzing each of the browser elements within the set to determine which are normal and which are anomalous at block 802 and taking an action to differentiate the browser elements determined to be anomalous from the browser elements determined to be normal at block 803. The computer-implemented method may further include shortening each of the multiple browser elements at block 804.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer program product for intelligent browser element classification in web browsers where multiple browser elements are open, the computer program product comprising a computer readable storage medium having program instructions embodied therewith, the program instructions being readable and executable by a processing circuit to cause the processing circuit to:
identify a set of similar browser elements from among the multiple browser elements from an analysis of the multiple browser elements;
analyze each of the browser elements within the set to determine which are normal and which are anomalous; and
take an action to differentiate the browser elements determined to be anomalous from the browser elements determined to be normal.

2. The computer program product according to claim 1, wherein the multiple browser elements comprise Jenkins server build browser elements.

3. The computer program product according to claim 1, wherein the program instructions further cause the processing circuit to shorten each of the multiple browser elements.

4. The computer program product according to claim 1, wherein an identification of the set of similar browser elements comprises a document object model (DOM) tree crawl for specific web pages, similar web page URLs, similar headers and similar page structures.

5. The computer program product according to claim 1, wherein an analysis of each of the browser elements within the set comprises a content analysis.

6. The computer program product according to claim 1, wherein an analysis of each of the browser elements within the set comprises analyses of network traffic and asynchronous JavaScript and XML (AJAX) updates.

7. The computer program product according to claim 1, wherein a taking of the action comprises a highlighting of the browser elements determined to be anomalous.

8. A computing system for intelligent browser element classification in web browsers where multiple browser elements are open, the computing system comprising a computer readable storage medium having instructions stored thereon that are executable by a processing circuit to cause the processing circuit to:
identify a set of similar browser elements from among the multiple browser elements from an analysis of the multiple browser elements;
analyze each of the browser elements within the set to determine which are normal and which are anomalous; and
take an action to differentiate the browser elements determined to be anomalous from the browser elements determined to be normal.

9. The computing system according to claim 8, wherein the multiple browser elements comprise Jenkins server build browser elements.

10. The computing system according to claim 8, wherein the instructions further cause the processing circuit to shorten each of the multiple browser elements.

11. The computing system according to claim 8, wherein an identification of the set of similar browser elements comprises a document object model (DOM) tree crawl for specific web pages, similar web page URLs, similar headers and similar page structures.

12. The computing system according to claim 8, wherein an analysis of each of the browser elements within the set comprises a content analysis.

13. The computing system according to claim 8, wherein an analysis of each of the browser elements within the set comprises analyses of network traffic and asynchronous JavaScript and XML (AJAX) updates.

14. The computing system according to claim 8, wherein a taking of the action comprises a highlighting of the browser elements determined to be anomalous.

15. A computer-implemented method for intelligent browser element classification in web browsers where multiple browser elements are open, comprising:
identifying a set of similar browser elements from among the multiple browser elements from an analysis of the multiple browser elements;
analyzing each of the browser elements within the set to determine which are normal and which are anomalous; and
taking an action to differentiate the browser elements determined to be anomalous from the browser elements determined to be normal.

16. The computer-implemented method according to claim 15, wherein the multiple browser elements comprise Jenkins server build browser elements.

17. The computer-implemented method according to claim 15, further comprising shortening each of the multiple browser elements.

18. The computer-implemented method according to claim 15, wherein the identifying of the set of similar browser elements comprises crawling a document object model (DOM) tree for specific web pages, similar web page URLs, similar headers and similar page structures.

19. The computer-implemented method according to claim 15, wherein the analyzing of each of the browser elements within the set comprises at least one of analyzing content, network traffic and asynchronous JavaScript and XML (AJAX) updates.

20. The computer-implemented method according to claim 15, wherein the taking of the action comprises highlighting the browser elements determined to be anomalous.
